(19) United States
(12) Patent Application Publication
(10) Pub. No.: US 2025/0100513 A1
(43) Pub. Date: Mar. 27, 2025

(54) NOZZLE ASSEMBLY AND A SENSOR CLEANING SYSTEM INCLUDING THE SAME

(71) Applicants: HYUNDAI MOTOR COMPANY, Seoul (KR); KIA CORPORATION, Seoul (KR)

(72) Inventors: Hyun Woo Yoon, Hwaseong-si (KR); Hyong Do Chung, Anyang-si (KR); Sung Min Yang, Incheon (KR)

(73) Assignees: HYUNDAI MOTOR COMPANY, Seoul (KR); KIA CORPORATION, Seoul (KR)

(21) Appl. No.: 18/610,773

(22) Filed: Mar. 20, 2024

(30) Foreign Application Priority Data
Sep. 26, 2023 (KR) 10-2023-0128680

(51) Int. Cl. B60S 1/54; B60S 1/56

(52) U.S. Cl. CPC B60S 1/54; B60S 1/56

(57) ABSTRACT

A nozzle assembly for a sensor cleaning system of a vehicle. The nozzle assembly includes at least two nozzle passage portions and fluid is introduced into the at least two nozzle portions. The nozzle assembly includes a plurality of discharge ports configured to discharge the fluid flowing through the at least two nozzle passage portions out of the nozzle passage portions. The fluids introduced into the at least two nozzle passage portions flow independently of each other.

### CROSS-REFERENCE TO RELATED APPLICATION

This application claims, under 35 U.S.C. § 119 (a), the benefit of and priority to Korean Patent Application No. 10-2023-0128680, filed on Sep. 26, 2023, the entire contents of which are incorporated herein by reference.

### TECHNICAL FIELD

The present disclosure relates to a nozzle assembly, and more particularly to a nozzle assembly for a sensor cleaning system of a vehicle.

### BACKGROUND

Recently, a driver assistance system that assists a driver of a vehicle is mounted to the vehicle in order to secure safe traveling in various traveling situations. In addition to the driver assistance system, research and development on a self-driving vehicle capable of driving itself without driver intervention is being actively conducted.

For such a driver assistance system, various types of environment sensors capable of detecting surrounding environment in various ways are mounted to a self-driving vehicle. Environment sensors installed in the vehicle may be a radar, a Light Detection and Ranging (LiDAR) sensor, a camera, and the like.

Because these sensors are mounted on the external side of the vehicle, the sensing regions thereof may easily become dirty by foreign matters, such as dust, rain, or snow. In order to maintain good sensing performance, the sensors must be kept clean at a predetermined level or greater. For this reason, the vehicle is provided with a contamination detection device configured to detect contamination on the sensors and a sensor cleaning system configured to clean the sensors when the sensing region thereof is detected to be contaminated.

The above information disclosed in this Background section is provided only to enhance understanding of the background of the present disclosure, and therefore it may contain information that does not form the prior art that is already known to a person of ordinary skill in the art.

### SUMMARY

The present disclosure has been made in an effort to solve the above-described problems associated with the prior art, and it is an object of the present disclosure to provide a nozzle assembly capable of effectively and efficiently clean an environment sensor.

The object of the present disclosure is not limited to the foregoing, and other objects not mentioned herein should be clearly understood by one having ordinary skill in the art to which the present disclosure pertains based on the description below.

The features of the present disclosure to achieve the object of the present disclosure as described above and perform the characteristic functions of the present disclosure to be described later are as follows.

In one aspect, the present disclosure provides a nozzle assembly including at least two nozzle passage portions and a plurality of discharge ports. A fluid is introduced into the at least two nozzle portions, and the plurality of discharge ports may be configured to discharge the fluid flowing through the at least two nozzle passage portions out of the nozzle passage portions. The fluids introduced into the at least two nozzle passage portions flow independently of each other.

In another aspect, the present disclosure provides a sensor cleaning system including an environment sensor, and a nozzle assembly connected to the environment sensor and configured to spray a fluid onto the environment sensor. The nozzle assembly may include at least two nozzle passage portions into which the fluids are introduced, and a plurality of discharge ports configured to discharge the fluid flowing through the at least two nozzle passage portions toward the environment sensor, and the fluids introduced into the at least two nozzle passage portions may flow independently of each other.

Other aspects and embodiments of the present disclosure are discussed below.

It is to be understood that the term “vehicle” or “vehicular” or other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed below.

### BRIEF DESCRIPTION OF THE DRAWINGS

The above and other features of the present disclosure are now described in detail with reference to certain embodiments thereof illustrated in the accompanying drawings which are given hereinbelow by way of illustration only, and thus are not limitative of the present disclosure, and wherein:

FIG. 1 illustrates an air cleaning system in an embodiment of the present disclosure;

FIG. 2 illustrates a LiDAR sensor mounted to a vehicle in an embodiment of the present disclosure;

FIG. 3 illustrates a LiDAR sensor to which a nozzle assembly is mounted in some forms of the present disclosure;

FIG. 4 illustrates a nozzle assembly according to an embodiment of the present disclosure;

FIG. 5A illustrates a first housing of a nozzle assembly according to an embodiment of the present disclosure;

FIG. 5B illustrates a second housing of a nozzle assembly according to an embodiment of the present disclosure;

FIG. 6 is a cross-sectional view taken along the dotted line B-B in FIG. 5B;

FIG. 7 illustrates a discharge port in a nozzle assembly according to an embodiment of the present disclosure;

FIG. 8 illustrates a LiDAR sensor to which a nozzle assembly is mounted in an implementation of the present disclosure;

FIG. 9 is a cross-sectional view of a nozzle assembly according to an embodiment of the present disclosure;

FIG. 10 is a cross-sectional view taken along the dotted line C-C in FIG. 5B;

FIG. 11 illustrates a LiDAR sensor to which a nozzle assembly is mounted in an implementation of the present disclosure, viewed from the bottom; and

FIG. 12 is a partial enlarged view of FIG. 11.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, should be determined in part by the particular intended application and usage environment.

In the figures, the reference numbers refer to the same or equivalent parts of the present disclosure throughout the several figures of the drawing.

### DETAILED DESCRIPTION

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

Meanwhile, in the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of exemplary embodiments of the present disclosure.

It should be understood that, when a component is referred to as being “connected to” another component, the component may be directly connected to the other component, or intervening components may also be present. In contrast, when a component is referred to as being “directly connected to” or “directly brought into contact with” another component, there is no intervening component present. Other terms used to describe relationships between components should be interpreted in a like fashion (e.g., “between” versus “directly between,” “adjacent” versus “directly adjacent,” etc.). When a component, device, element, or the like of the present disclosure is described as having a purpose or performing an operation, function, or the like, the component, device, or element should be considered herein as being “configured to” meet that purpose or to perform that operation or function.

Throughout the specification, like reference numerals indicate like components. The terminology used herein is for the purpose of illustrating embodiments and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements.

Hereinafter, the present disclosure is described in detail with reference to the accompanying drawings.

As described above, a self-driving vehicle, a vehicle equipped with a driver assistance system, and the like have mounted thereon various types of environment sensors configured to detect surrounding environment. As a non-limiting example, the environment sensor may include a LiDAR sensor, a radar, a camera, and the like. and the environment sensor may be mounted on the front FR, rear, sides, roof R, etc., of the vehicle.

Because a vehicle is mostly outdoors and in motion, environment sensors mounted on the external side of the vehicle may be contaminated not only by rain but also by foreign matters, such as dust and insects. For this reason, a sensor cleaning system is provided in the vehicle to clean the contaminated environment sensors. Cleaning of the environment sensors may be performed by using a washer fluid or by injecting high-pressure compressed air.

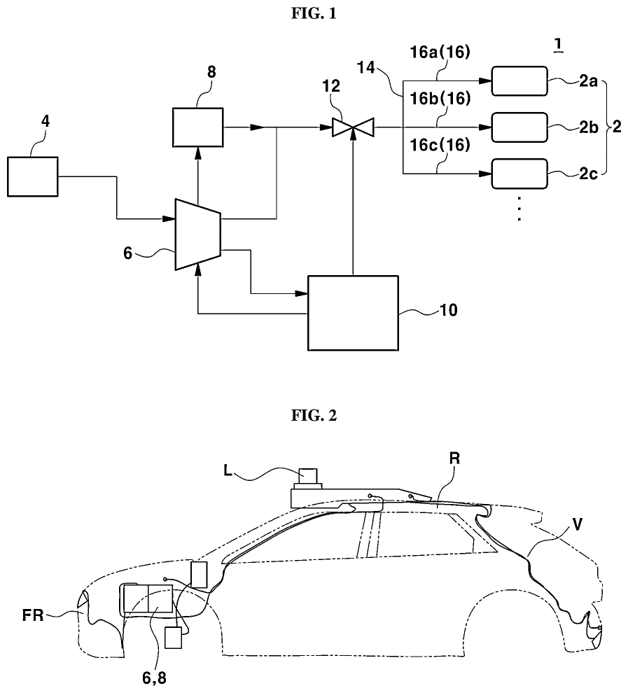

FIG. 1 illustrates an air cleaning system mounted to a vehicle, according to an embodiment of the present disclosure. The air cleaning system 1 (i.e., a type of the sensor cleaning system) is configured to clean an environment sensor 2 using compressed air. The air cleaning system 1 performs cleaning by spraying compressed air on the surface of the environment sensor 2.

Specifically, air filtered through an air filter 4 provided in the vehicle is introduced into a compressor 6. The air is compressed in the compressor 6 and then is sprayed onto the surface of the environment sensor 2 to remove foreign matters from the environment sensor 2. The environment sensor 2 includes a plurality of environment sensors 2a, 2b, 2c, and may be mounted on the front (FR), rear, roof (R), sides, etc. of the vehicle. Although three environment sensors are described in this specification and the drawings, the number of the environment sensors is not limited thereto and may be increased or decreased.

Moreover, the air cleaning system 1 includes an air tank 8. The air tank 8 may be filled with air compressed by the compressor 6 or air filled by an external device. The air in the air tank 8 may be used for cleaning the environment sensor 2.

The air cleaning system 1 includes a controller 10 configured to operate a valve 12, for example, a solenoid valve, at each preset cycle or in a predetermined situation, such as when the environment sensor 2 detects contamination of the environmental sensor 2. Accordingly, the compressed air is sprayed from the compressor 6 or from the air tank 8 to each of the environment sensors 2 to clean the environment sensors 2. The valve 12 may be provided with a distributor 14 to distribute the compressed air through nozzles 16a, 16b, 16c, (collectively, 16), each for a corresponding one of the environment sensors 2.

The controller 10 is configured to control the operation of the air cleaning system 1. For example, the controller 10 opens the valve 12 to clean the environment sensor 2 when needed.

Similar to the air cleaning system 1, a washer fluid cleaning system, which is a type of the sensor cleaning system, may be configured to supply a washer fluid stored in a vehicle to environment sensors each disposed at a predetermined position on the vehicle.

As illustrated in FIG. 2, a LiDAR sensor (L), in particular, among the environment sensors, is installed on the roof (R) of the vehicle (V). Like the other environment sensors, compressed air may be supplied to the LiDAR sensor L from the compressor 6 or from the air tank 8, which is usually disposed at the front FR of the vehicle V. When needed, the controller 10 may perform cleaning by spraying the compressed air onto the LiDAR sensor L. However, the LiDAR sensor L is open at 360° and thus is exposed to more pollutants than the other environment sensors are. In other words, the LiDAR sensor on a vehicle has the ability to scan its surroundings in a complete circle or sphere, covering a full 360-degree field of view, and thus the LiDAR sensor is exposed to more pollutants than other sensors.

For this reason, the present disclosure provides a nozzle assembly and a sensor cleaning system including the same capable of effectively cleaning the LiDAR sensor L, in particular, among the environment sensors. Specifically, the present disclosure provides a nozzle assembly configured to more effectively clean an environment sensor, such as a LiDAR sensor L having a large operation area. However, the nozzle assembly according to the present disclosure may be adopted not only to the LiDAR sensor but also to other environment sensors. Particularly, for an environment sensor with a large sensing area, it is advantageous to adopt the injection structure of the present disclosure.

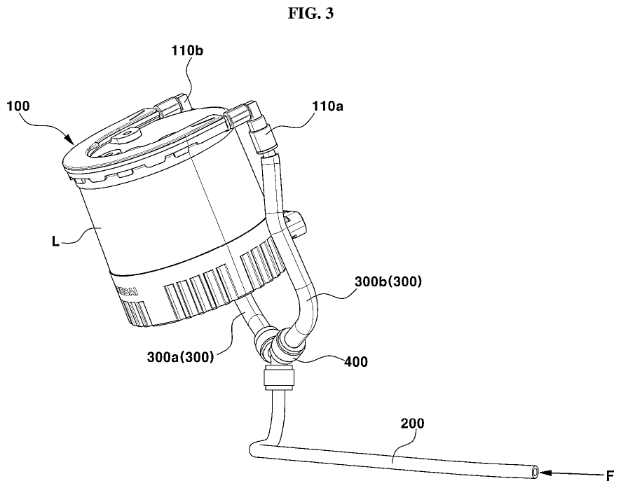

As illustrated in FIG. 3, a nozzle assembly 100 according to the present disclosure is configured to spray a fluid or compressed air. Specifically, the nozzle assembly 100 may spray compressed air onto the LiDAR sensor L. The compressed air may be supplied from the compressor 6 or from the air tank 8. When the LiDAR sensor L needs to be cleaned, the controller 10 may open the valve 12 so that the compressed air is supplied to the nozzle assembly 100. The nozzle assembly 100 may be one of the nozzles 16 in FIG. 1.

In one implementation, the nozzle assembly 100 may be integrated with the LiDAR sensor L. In another implementation, the nozzle assembly 100 may be separated from the LiDAR sensor L and be assembled to the LiDAR sensor L. To this end, the nozzle assembly 100 may include a plurality of fastening portions 102 to be mounted to the LiDAR sensor L.

The compressed air is supplied to the nozzle assembly 100 from the compressor 6 or from the air tank 8. The compressed air may be supplied to the nozzle assembly 100 through a main passage 200 and branched passages 300. The main passage 200 is connected to the compressor 6 or to the air tank 8 via the valve 12. The compressed air is supplied to the main passage 200 in a flow direction F. A connector 400 may be provided downstream of the main passage 200 with respect to the flow direction F. The connector 400 may divide the flow of the compressed air flowing through the main passage 200 into two or more branches. The flow of the compressed air divided into two or more branches is transmitted to two or more branched passages 300 each connected to the connector 400.

The branched passages 300 include a first passage 300a and a second passage 300b. Each of the first passage 300a and the second passage 300b is connected to the nozzle assembly 100 to fluidly communicate with the nozzle assembly 100.

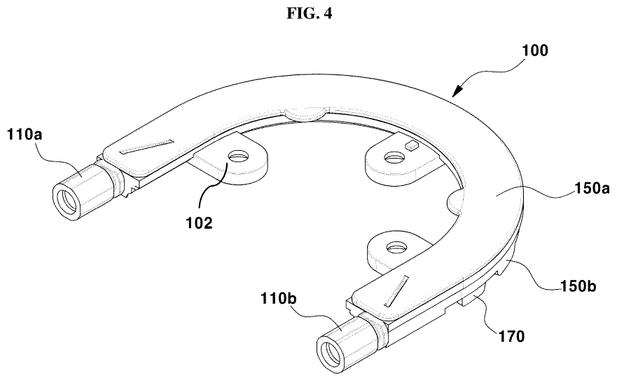

As illustrated in FIG. 4, the nozzle assembly 100 includes inlets 110a, 110b. In one implementation, the nozzle assembly 100 may include one or more of inlets 110a, 110b. The branched passage 300 is connected to each of the inlets 110a, 110b in fluid communication therewith. In one implementation, the number of the inlets 110a, 110b may be equal to the number of the branched passages 300.

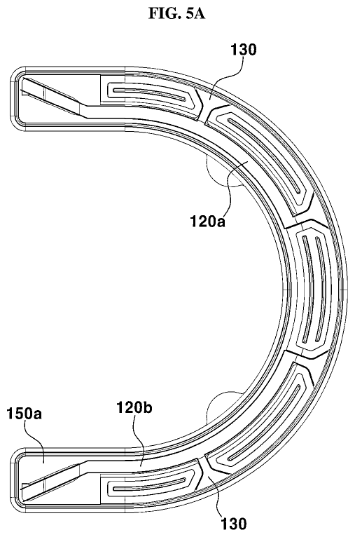

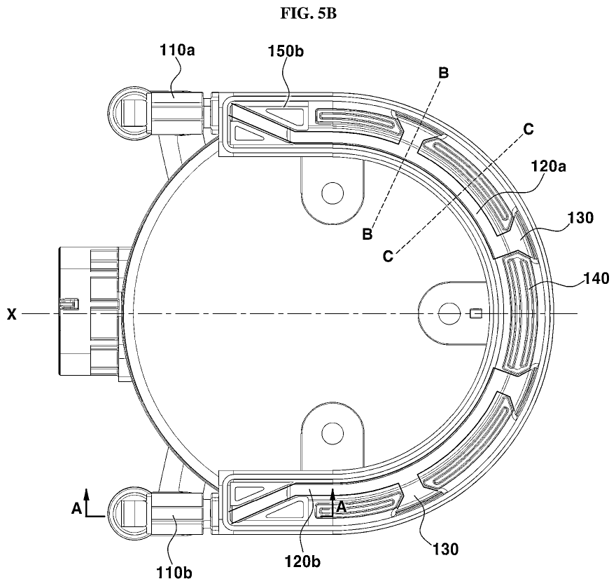

As illustrated in FIGS. 5A and 5B, the nozzle assembly 100 includes nozzle passage portions 120a, 120b. Each of the nozzle passage portions 120a, 120b includes a discharge port 130. The compressed air introduced into the nozzle assembly 100 through each of the inlets 110a, 110b flows within the nozzle assembly 100 along the nozzle passage portions 120a, 120b. The compressed air flowing through the nozzle assembly 100 may be sprayed onto the LiDAR sensor L through the discharge port 130.

In some implementations, the nozzle assembly 100 may include a plurality of discharge ports 130. The plurality of the discharge ports 130 may be separated from each other by predetermined distances in the nozzle assembly 100. The discharge ports 130 provided in this way may clean the LiDAR sensor L evenly. In the illustrated embodiment, four discharge ports are shown, but this is only an example, and the number of the discharge ports may be increased or decreased. However, the number of the discharge ports 130 formed in the nozzle passage portion 120a may be equal to the number of the discharge ports 130 formed in the nozzle passage portion 120b.

According to an implementation of the present disclosure, the nozzle assembly 100 may include a first housing 150a and a second housing 150b. The first housing 150a and the second housing 150b may be coupled to each other to form the nozzle passage portions 120a, 120b and the discharge ports 130. In some implementations, one of the first housing 150a and the second housing 150b may include the nozzle passage portions 120a, 120b and the discharge ports 130, and the other one of the first housing 150a and the second housing 150b may serve as a cover. In some implementations, the first housing 150a may be integrated with the second housing 150b.

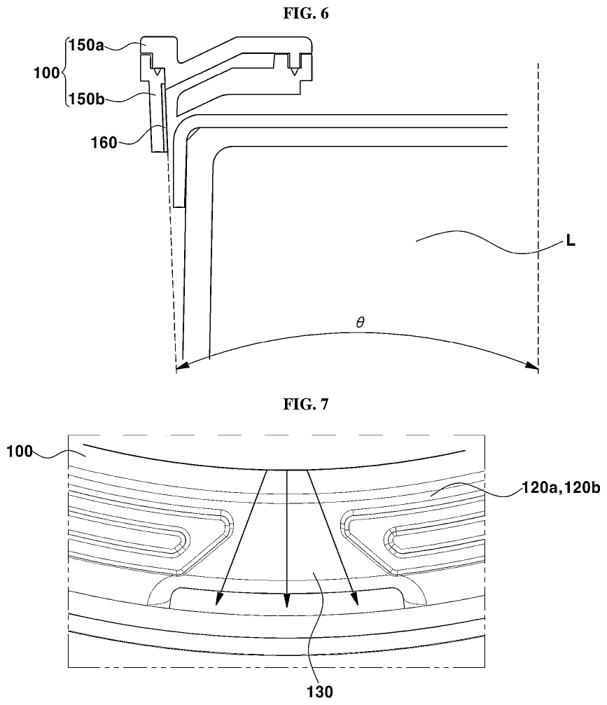

Referring to FIG. 6, the nozzle assembly 100 may include a guide surface 160. The guide surface 160 may be provided in the second housing 150b to face the discharge port 130. The guide surface 160 may have a predetermined angle θ with respect to a vertical line or the central axis of the LiDAR sensor L. The angle θ may range from 1° to 45°. The guide surface 160 serves to guide the flow of the compressed air discharged through the discharge port 130 so that the compressed air may smoothly reach the surface of the LiDAR sensor L.

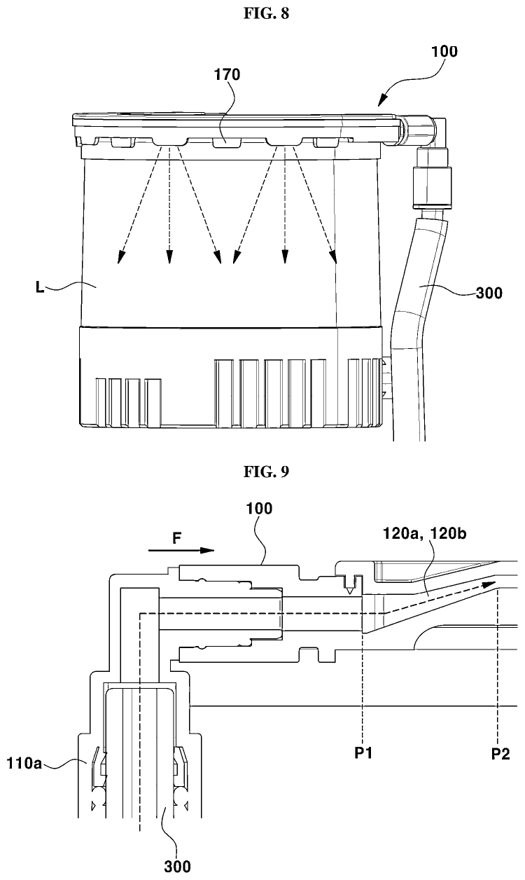

Referring to FIG. 7, in some implementations, the cross-sectional area of the discharge port 130 may be configured to gradually increase from the nozzle passage portion 120a or 120b in the flow direction of the compressed air. In other words, the cross-sectional area of the discharge port 130 at a point where the compressed air is sprayed onto the LiDAR sensor L is greater than the cross-sectional area of the discharge port 130 at a point where the discharge port 130 is connected to the nozzle passage portion 120a or 120b. For example, the discharge port 130 may have a fan shape having a cross-sectional area that incrementally expands in a direction away from the nozzle passage portions. Therefore, as illustrated in FIG. 8, the compressed air sprayed through the discharge port 130 may be sprayed widely onto the surface of the LiDAR sensor L.

In some implementations, at least two nozzle passage portions 120a, 120b may be separated from each other in the nozzle assembly 100. In other words, the flow of the compressed air between the nozzle passage portions 120a and 120b is blocked. The compressed air introduced into the first nozzle passage portion 120a via a first inlet 110a is sprayed only through the dedicated discharge port 130 that is in communication with the first nozzle passage portion 120a. If the compressed air is introduced into the second nozzle passage portion 120b via a second inlet 110b, the compressed air is sprayed only through another dedicated discharge port 130 communicating with the second nozzle passage portion 120b.

In order to separate the first nozzle passage portion 120a from the second nozzle passage portion 120b, the nozzle assembly 100 includes a partition wall 140. The partition wall 140 blocks fluid communication between the first nozzle passage portion 120a and the second nozzle passage portion 120b. This allows the compressed air passing through the first nozzle passage portion 120a and the compressed air passing through the second nozzle passage portion 120b to flow independently of each other. Two portions of the nozzle assembly 100 divided by a line X may be symmetrical to each other. The partition wall 140 separates the first nozzle passage portion 120a and the second nozzle passage portion 120b from each other to prevent fluid communication therebetween so that the compressed air supplied to the nozzle assembly 100 flows through each of the nozzle passage portions 120a and 120b while maintaining a predetermined pressure or higher. Although the number of the partition wall 140 is described here to be one, the number thereof may be increased. For example, the number of the partition wall 140 may be adjusted together with the number of the inlets 110a, 110b. In other words, the quantity of the partition walls 140 can be modified in conjunction with the number of inlets 110a, 110b.

Referring to FIG. 9, the cross-sectional area of the nozzle passage portion 120a or 120b may gradually decrease from the inlet 110a or 110b to a predetermined point. Specifically, the cross-sectional area of the nozzle passage portion 120a or 120b may gradually decrease from an upstream point P1 to a downstream point P2. Accordingly, the flow rate of the compressed air passing downstream of the inlet 110a or 110b in the flow direction F may be greater than the flow rate of the compressed air passing upstream of the inlet 110a or 110b.

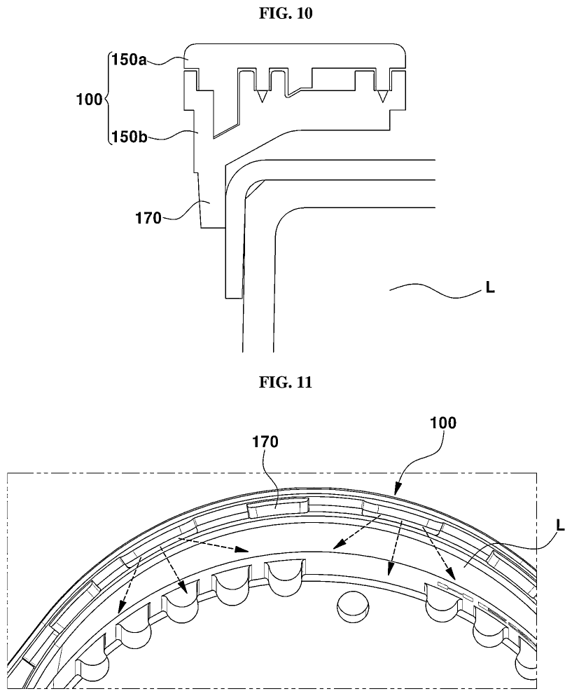

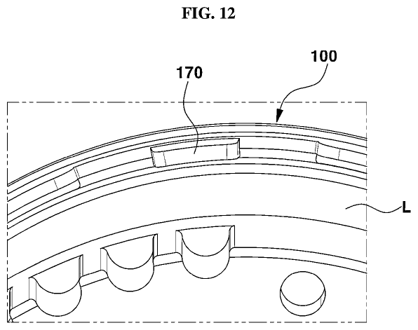

Referring to FIGS. 10 to 12, the nozzle assembly 100 may include a stopper 170. The stopper 170 may be included in the second housing 150b and may be disposed between two neighboring discharge ports 130. An actual width of the discharge port 130 is very small. When the nozzle assembly 100, separated from the LiDAR sensor L, is mounted to the LiDAR sensor L, the nozzle assembly 100 may easily deviate from its originally designated position. In this case, the compressed air may not move in accordance with intended design, rendering it difficult to properly clean the surface of the LiDAR sensor L. Therefore, when the nozzle assembly 100 and the LiDAR sensor L are independent components, the stopper 170 keeps a predetermined gap between the discharge ports 130 and the LiDAR sensor L to prevent the nozzle assembly 100 from deviating from its designated position.

As in the illustrated implementation, the nozzle assembly 100 according to the present disclosure may be adopted to a LiDAR sensor L having a sensing area of about 180°. However, the nozzle assembly 100 according to the present disclosure may also be adopted to a LiDAR sensor L having a sensing area of a different angle other than 180°. For example, even in the case of a LiDAR sensor L having a sensing area of 240°, a range of 120° of the LiDAR sensor L may be covered by including one partition wall 140 and two nozzle passage portions 120a, 120b.

The nozzle assembly 100 according to the present disclosure may effectively and efficiently clean the environment sensor having a large sensing surface, like the LiDAR sensor L.

As is apparent from the above description, the present disclosure provides the following effect.

According to the present disclosure, provided is a nozzle assembly and a sensor cleaning system including the same, enabling effective and efficient cleaning of an environment sensor.

Effects of the present disclosure are not limited to what has been described above,

and other effects not mentioned herein should be clearly recognized by those having ordinary skill in the art based on the above description.

It should be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

What is claimed is:

1. A nozzle assembly comprising:
at least two nozzle passage portions, wherein a fluid is introduced into the at least two nozzle passage portions; and
a plurality of discharge ports configured to discharge the fluid flowing through the at least two nozzle passage portions,
wherein the fluid introduced into the at least two nozzle passage portions is configured to flow independently of each other.

2. The nozzle assembly of claim 1, further comprising a partition wall configured to prevent fluid communication between the at least two nozzle passage portions.

3. The nozzle assembly of claim 1, wherein each cross-sectional area of the plurality of the discharge ports is configured to incrementally expand in a direction away from a corresponding nozzle passage portion among the at least two nozzle passage portions.

4. The nozzle assembly of claim 1, further comprising a guide surface facing a discharge port of the plurality of the discharge ports, wherein the guide surface is configured to guide the fluid to flow through the discharge port.

5. The nozzle assembly of claim 1, wherein the each of the at least two nozzle passage portions has a cross-sectional area decreasing at a predetermined distance from a point where the fluid is introduced.

6. The nozzle assembly of claim 1, wherein the fluid is compressed air.

7. A sensor cleaning system comprising:
an environment sensor; and
a nozzle assembly connected to the environment sensor and configured to spray a fluid onto the environment sensor,
wherein the nozzle assembly comprises:
at least two nozzle passage portions, wherein the fluid is introduced into the at least two nozzle passage portions; and
a plurality of discharge ports configured to discharge the fluid flowing through the at least two nozzle passage portions toward the environment sensor, and
wherein the fluid introduced into the at least two nozzle passage portions is configured to flow independently of each other.

8. The sensor cleaning system of claim 7, further comprising a partition wall configured to prevent fluid communication between the at least two nozzle passage portions.

9. The sensor cleaning system of claim 7, wherein each cross-sectional area of the plurality of the discharge ports is configured to incrementally expand toward the environment sensor.

10. The sensor cleaning system of claim 7, wherein the at least two nozzle passage portions are respectively connected to a first passage and a second passage through which the fluid is supplied.

11. The sensor cleaning system of claim 10, further comprising a main passage branched into the first passage and the second passage, wherein the main passage allows compressed air to be supplied thereinto.

12. The sensor cleaning system of claim 7, further comprising a stopper configured to separate the nozzle assembly from the environment sensor by being disposed between neighboring discharge ports among the plurality of the discharge ports.

13. The sensor cleaning system of claim 7, wherein the nozzle assembly is integrated with the environment sensor.

14. The sensor cleaning system of claim 7, wherein the environment sensor is a Light Detection and Ranging (LiDAR) sensor mounted to a vehicle.

15. The sensor cleaning system of claim 7, wherein the sensor cleaning system is configured to clean the environment sensor mounted to a vehicle.
